(19) United States
(12) Patent Application Publication
(10) Pub. No.: US 2002/0087829 A1
(43) Pub. Date: Jul. 4, 2002

(54) Re-targetable communication system

(76) Inventors: Walter L. Snyder, San Jose, CA (US); Ernest T. Tsui, Cupertino, CA (US)

Correspondence Address: Edwin H. Taylor, Blakely, Sokoloff, Taylor & Zafman LLP, Seventh Floor, 12400 Wilshire Boulevard, Los Angeles, CA, 90025-1030, US

(21) Appl. No.: 09/751,432

(22) Filed: Dec. 29, 2000

(51) Int. Cl. G06F 15/00

(52) U.S. Cl. 712/34

(57) ABSTRACT

A re-targetable communication system is disclosed. In one embodiment, the system includes a connectivity unit, a digital signal processing core that is coupled to the connectivity unit and a number of scaleable functional units that are coupled to the connectivity unit. The scaleable functional units have been optimized to execute mathematically intensive operations. Each of the units further includes a local memory, a bus controller and a number of removable complex arithmetic elements (hereinafter CAE) that are coupled to one another, to the local memory and to an inter-CAE bus. The bus controller is coupled to the inter-CAE bus and to the connectivity unit.

### FIELD OF THE INVENTION

This invention relates to communications technologies generally and particularly to a re-targetable communication system.

### BACKGROUND OF THE INVENTION

Many of the existing communication apparatus designs utilize fixed function hardware accelerator(s), digital signal processing (hereinafter DSP) cores or a combination of the two to carry out functions that are specified by various communications standards. Some examples of these communications standards are for digital subscriber lines, cable modems, integrated services digital network, T-1 lines, wireless communications, analog and digital modems, etc. Because communications standards tend to evolve over time, system designers and architects often favor designs that are sufficiently flexible to adopt such evolution.

Unlike their fixed function hardware counterpart, DSP cores often provide the requisite flexibility and the processing capabilities to support functions of one communications standard. However, DSP cores are relatively expensive and have relatively sizable physical dimensions. Furthermore, designs that attempt to utilize DSP cores alone typically fail to handle multiple communications standards, especially the standards for high-speed communications, in a cost-effective manner.

An alternative prior art approach is to utilize fixed function hardware, such as Application Specific Integrated Circuits (hereinafter ASICs), in combination with DSP cores. In particular, the approach dedicates the ASICs to execute certain operations in order to alleviate any resource constraints that the DSP cores may encounter. However, ASICs lack the flexibility of a programmable device. Thus, this approach is likely to only work cost effectively for a fixed number and set of communications standards. In other words, a system resulting from the approach is neither capable of effectively adjusting to changes in its set of communications standards, nor is the system scaleable to efficiently accommodate a varying number of communications standards.

Therefore, in order to further improve the price/performance of communication gears, an apparatus and a design approach is needed to provide a flexible, programmable and highly scaleable solution for such gears to handle multiple communications standards in a cost effective manner.

### BRIEF DESCRIPTION OF THE DRAWINGS

The present invention is illustrated by way of example and is not limited by the figures of the accompanying drawings, in which like references indicate similar elements, and in which:

FIG. 1 illustrates a block diagram of one embodiment of the present invention, a re-targetable communication system.

FIG. 2 illustrates a general block diagram of one embodiment of a scaleable function unit.

FIG. 3 illustrates a block diagram of a general-purpose computer system, which includes one embodiment of a re-targetable communication system.

FIG. 4 illustrates a block diagram of one embodiment of a complex arithmetic element.

FIG. 5(a) illustrates a block diagram of one embodiment of an arithmetic unit.

FIG. 5(b) illustrates a block diagram of one embodiment of a Multiplier/Accumulator engine.

FIG. 6 illustrates a block diagram of one embodiment of a data router.

### DETAILED DESCRIPTION

A re-targetable communication system is disclosed. In the following description, numerous specific details are set forth in order to provide a thorough understanding of the present invention. However, it will be apparent to one of ordinary skill in the art that the invention may be practiced without these particular details. In other instances, well known elements and theories have not been described in special detail in order to avoid obscuring the present invention.

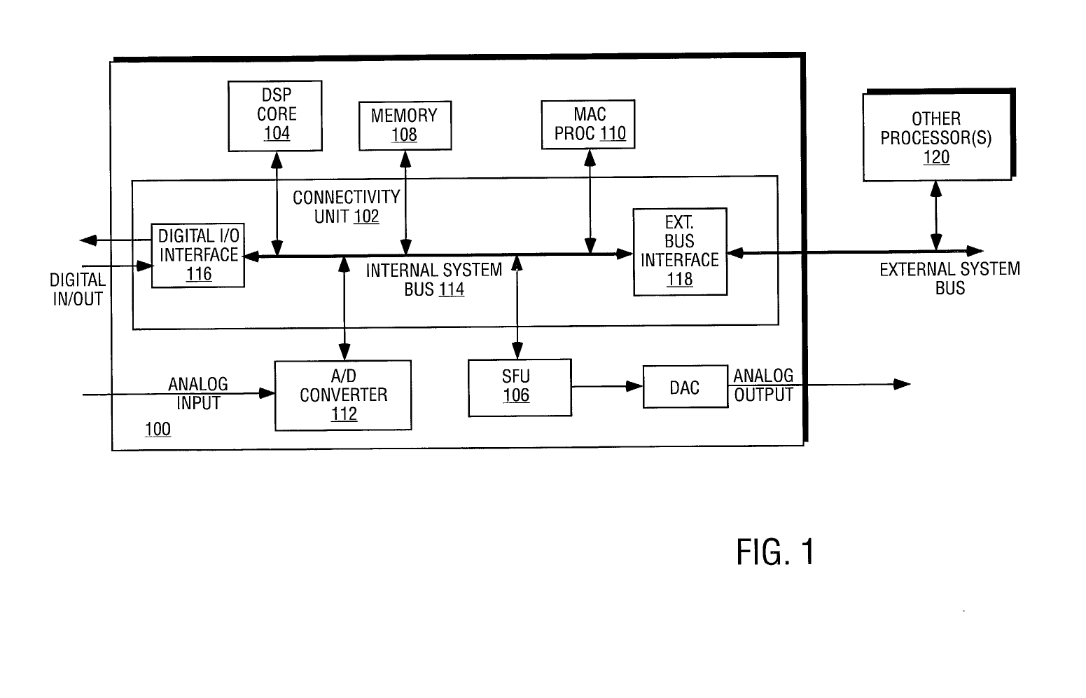

FIG. 1 illustrates a block diagram of one embodiment of the present invention, re-targetable communication system 100. Specifically, one implementation of re-targetable communication system 100 involves a single integrated circuit (hereinafter IC) device and mainly includes connectivity unit 102, digital signal processing (hereinafter DSP) core 104 and a number of scaleable functional units (hereinafter SFU), such as SFU 106. This single-IC embodiment of re-targetable communication system 100 is also referred to as a re-targetable communication processor in the subsequent discussions.

Connectivity unit 102 is designed to generically operate with any number and types of plug-in modules. Thus, adding or removing a plug-in module would not involve a re-design of connectivity unit 102. In addition to the mentioned DSP core 104 and a number of the SFUs, some examples of the plug-in modules can be, but not limited to, memory 108, media access control processor 110, analog-to-digital converter 112, additional DSP cores, Micro-controller cores, etc. DSP core 104, on the other hand, broadly refers to a programmable computational unit that performs the mathematics involved in digital signal processing algorithms.

One embodiment of connectivity unit 102 further includes internal system bus 114, digital input/output interface 116 and external bus interface 118. Digital input/output interface 116 allows communications system 100 to handle parallel input/output, interrupt requests, direct memory access, reset events, etc. On the other hand, external bus interface 118 allows communication system 100 to communicate with other processor(s) 120 including other re-targetable communications processors, which may or may not physically reside in the same system or apparatus that retargetable communication system 100 is in. Lastly, internal system bus 114 provides a common path for the plug-in modules and the various interfaces to communicate among one another.

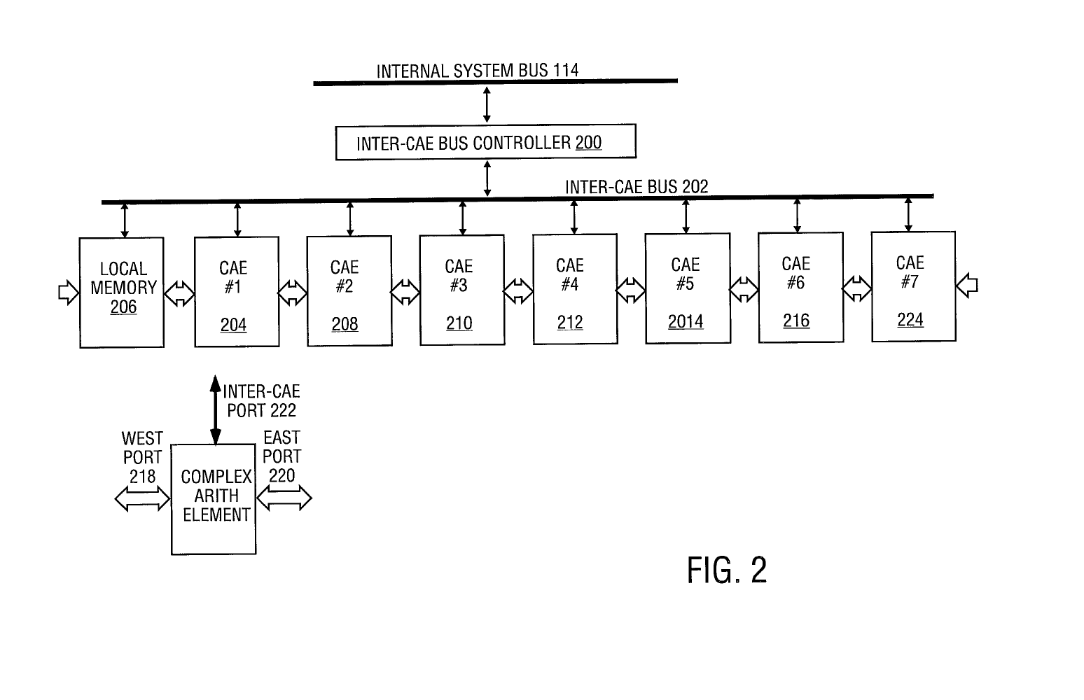

FIG. 2 illustrates a general block diagram of one embodiment of SFU 106. For illustration purposes, the following discussions assume that this embodiment mainly operates as a numeric accelerator that has been optimized to execute digital signal processing algorithms. It should however be noted that SFU 106 could apply to other types of operations, such as forward error correction operations. Additionally, although this disclosure mainly describes re-targetable communication system 100 with a single SFU, the present invention is capable of supporting as many SFUs as its design and cost parameters permit.

SFU 106 includes a number of removable complex arithmetic elements (hereinafter CAEs) that are optimized for mathematically intensive operations, such as, but not limited to, Fast Fourier Transforms (hereinafter FFT), Least-Mean-Square (hereinafter LMS) adaptive filters, LMS echo cancellations, LMS adaptive equalizers, Finite Impulse Response (hereinafter FIR) filter, convolution, interpolation, decimation, tuners, resamplers, etc. SFU 106 also has an inter-CAE bus controller 200 and local memory 206.

Inter-CAE bus controller 200 not only bridges communications between SFU 106 and internal system bus 114 of connectivity unit 102, but it also regulates data traffic on inter-CAE bus 202. Each CAE has west port 218 and east port 220 that allow direct communications with its neighboring CAEs. For example, CAE 208 has direct connections with its west neighboring CAE, or CAE 204, its east neighboring CAE, or CAE 210. The direct connections between CAEs help ease some traffic on inter-CAE bus 202. Aside from communicating with its neighboring CAEs, each CAE also can communicate with its non-neighboring CAEs via inter-CAE port 222 and inter-CAE bus 202. In addition, all CAEs have access to local memory 206, which often contains lookup tables for information such as, but not limited to, sine and cosine values, magnitude and phase angle, symbol decisions, etc. Because the individual CAE has a certain amount of processing capability and the CAEs in SFU 106 operate in parallel, the overall processing capability of SFU 106 is directly related to the number of CAEs in SFU106. In other words, SFU 106 is readily scaleable by varying the number of CAEs that it has.

Operation of One Embodiment of a Complex Arithmetic Element in One Embodiment of a Re-Targetable Communication System

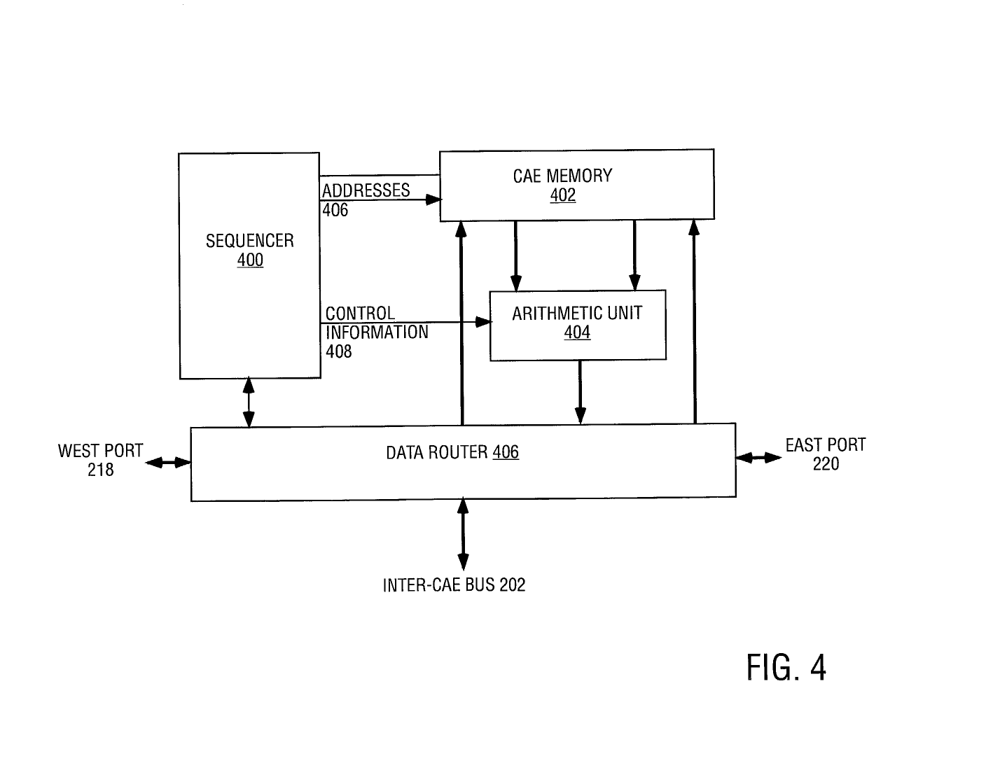

FIG. 4 illustrates a block diagram of one embodiment of a CAE, such as CAE 204 as shown in FIG. 2. Specifically, CAE 204 includes sequencer 400, CAE memory 402, arithmetic unit 404 and data router 406. Sequencer 400 is responsible for generating addresses 406 for CAE memory 402 and for issuing control information 408 to arithmetic unit 404. Data router 406 is responsible for providing CAE 204 connections to both its neighboring and non-neighboring CAEs and for routing appropriate data to sequencer 400 and CAE memory 402. CAE memory 402 provides temporary data storage for arithmetic unit 404.

In response to control information 408 from sequencer 400, arithmetic unit 404 proceeds to execute certain targeted operations on data stored in CAE memory 402. In one embodiment, arithmetic unit 404 operations span several clock cycles. Control information 408 also similarly spans several clock cycles to match arithmetic unit 404. The subsequent paragraphs use one type of digital signal processing operation, the LMS adaptive filter to describe one optimized implementation of arithmetic unit 404. The LMS adaptive filter generally follows the steps set forth below:

1) performing a dot product between the input data to the filter and the filter coefficients;

2) calculating the error between the output of the filter and a desired output response of the filter;

3) adjusting the filter coefficients in response to the calculated error; and

4) continuously repeating steps 1-3 while the calculated error drops to an acceptable level.

Moreover, for optimal performance of this embodiment of arithmetic unit 404, CAE memory 402 includes two banks of separately addressable 64-bit wide data memories. The data memories may store 32-bit complex numbers (16-bit real and 16-bit imaginary), 64-bit long complex numbers (32-bit real and 32-bit imaginary), 16-bit real numbers, 32-bit long real numbers and 64-bit very long real numbers.

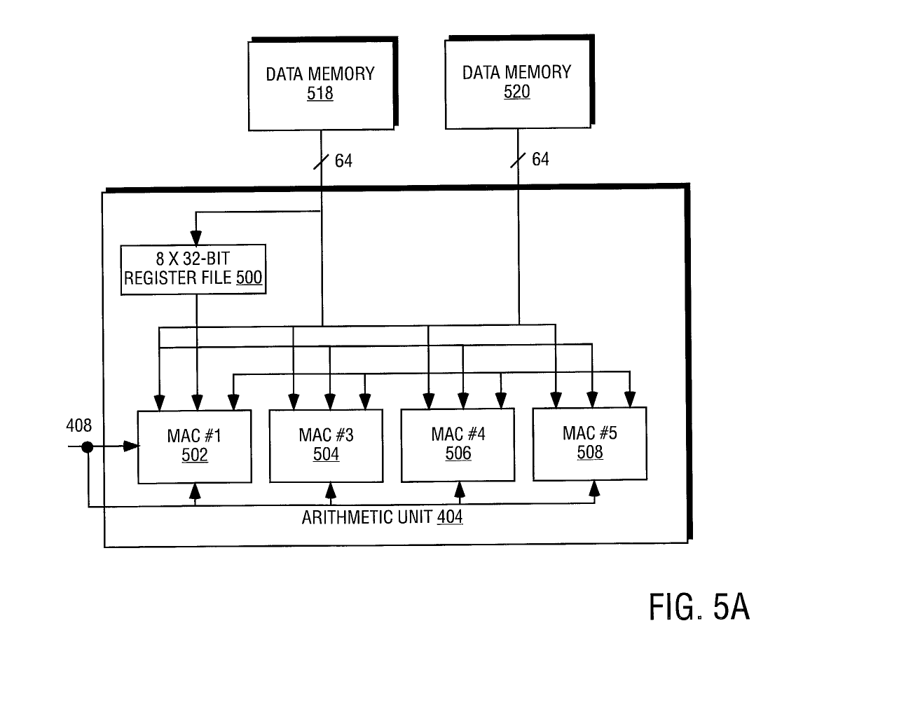

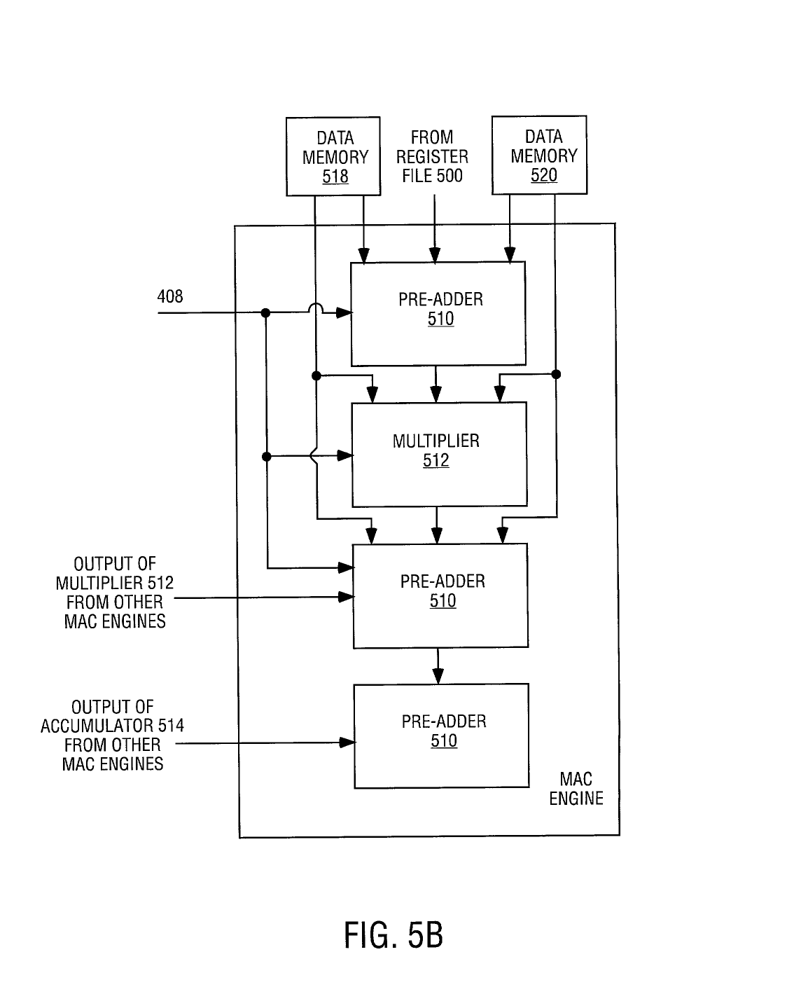

FIG. 5(a) illustrates one such embodiment of arithmetic unit 404. Specifically, the embodiment includes register file 500 and four multiplier-accumulator (hereinafter MAC) engines, 502, 504, 506 and 508 respectively. Each MAC engine is coupled to other MAC engines, register file 500 and the two banks of data memories, 518 and 520 respectively. For this LMS adaptive filter example, data memory 518 contains input data to the filter, and data memory 520 stores coefficient information of the filter. This combination of four MAC engines and two separately addressable data memories allow arithmetic unit 404 to perform, for instance, one 32-bit by 32-bit complex number or four 16-bit by 16-bit real number operations simultaneously.

Each MAC engine further includes four main functional blocks. FIG. 5(b) illustrates one embodiment of such a MAC engine. The four blocks are pre-adder 510, multiplier 512, accumulator 514 and data packing block 516. These blocks operate in accordance to control information 408 from sequencer 400 as shown in FIG. 4. Pre-adder 510 essentially sums up data from register file 500, which contains data from memories 518. Though in one implementation, based on control information 408, pre-adder 510 may further format the output of register file 500 and/or format its own summation output.

Multiplier 512 accepts data from both data memories 518 and 520 and pre-adder 510 and is mainly responsible for performing the multiplication between the filter's input data and the filter coefficients. In one embodiment, multiplier 512 has the capability to multiply either the output of pre-adder 510 or the data from data memories 518 with the filter coefficients from data memory 520. Furthermore, this embodiment of multiplier 512 includes a programmable shifter at the output of the multiplication, which allows arithmetic unit 404 to adjust the filter coefficients efficiently. The programmability of this shifter refers to the shifter's ability to shift right or left a varying number of bit positions according to control information 408.

Accumulator 514 accepts and sums up data from data memories 518 and 520, other MAC engines and multiplier 512. Similar to the mentioned embodiments of pre-adder 510 and multiplier 512, one embodiment of accumulator 514 has the flexibility to sum a selected multiplication output and data from data memories 518 and 520 in accordance to control signal 408. The embodiment also allows accumulator 514 to format the data before and after the addition operation. After accumulator 514 hands off data to data packing block 516, data packing block 516 organizes the data into a pre-defined format, such as 64-bit words.

Although the disclosed embodiment of arithmetic unit 404 enables CAE 204 to efficiently execute the LMS adaptive filter operations, the present invention further couples CAE 204 to other CAEs, each of which also contains the disclosed arithmetic unit 404s, so that they operate in parallel. The coupling of the CAEs is accomplished through data router 406 as shown in FIG. 4.

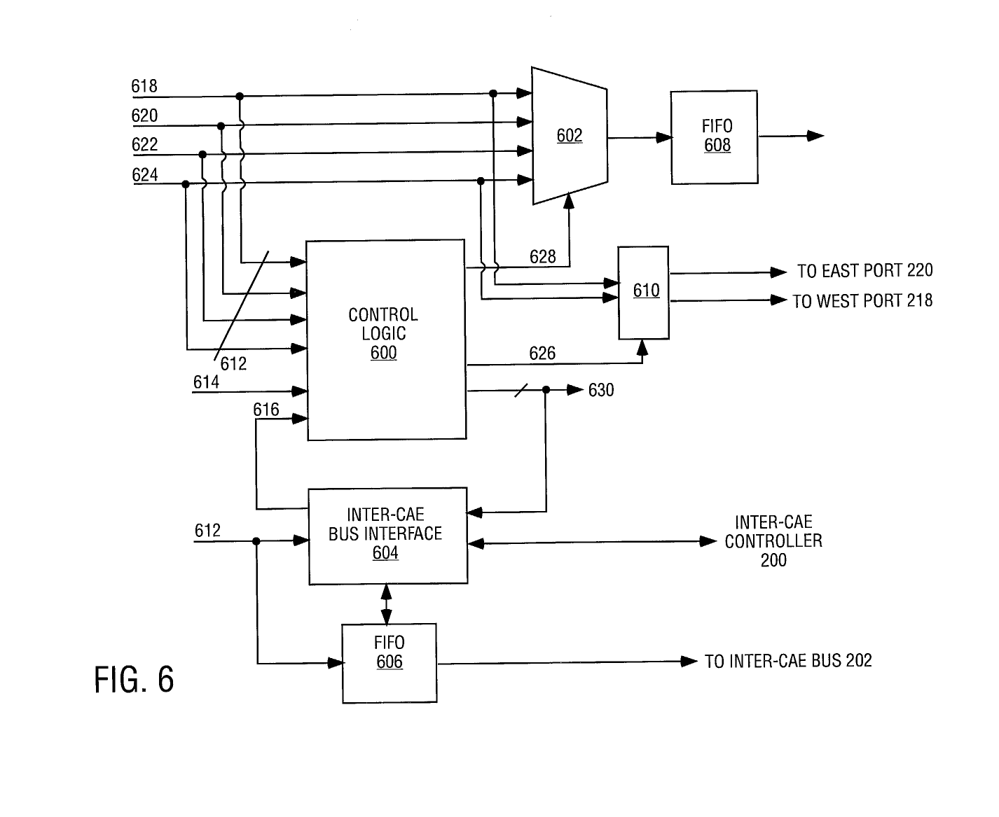

FIG. 6 illustrates a general block diagram of one embodiment of data router 406. In particular, the embodiment includes control logic 600, multiplexer 602, inter-CAE bus interface 604, first-in-first-out (hereinafter FIFO) buffer 606, FIFO buffer 608, and register 610. It should be noted that the following discussions on data router 406 would make a number of references to elements illustrated in FIGS. 2 and 4.

Control logic 600 manages the data flow to CAE 204's sequencer 400 and CAE memory 402, neighboring CAEs and inter-CAE bus 202. Specifically, one embodiment of control logic 600 uses information such as, but not limited to, destination device identifications 612, and status signals 614 and 616 indicative of the availability of the destination devices, etc. to generate a number of control and status signals. Destination device identifications 612 are derived from signals 618, 620, 622 and 624. Signal 618 represents data that CAE 204 receives via its east port 220. Signal 620 represents data from CAE 204's sequencer 400 and arithmetic unit 404. Signal 622 represents data that CAE 204 receives via its inter-CAE port 222 from inter-CAE bus 202. Lastly, signal 624 represents data that CAE 204 receives via its west port 218.

On the other hand, status signal 614 comes from neighboring CAEs of CAE 204, which indicate the ability of the neighboring CAEs to accept data. Status signal 616 comes from inter-CAE bus interface 604, which indicates the availability of the non-neighboring CAEs on inter-CAE bus 202 to accept data from CAE 204. One embodiment of inter-CAE bus interface 604 submits requests to inter-CAE bus controller 200 to access particular non-neighboring CAEs that are specified by destination device identifications 612. Inter-CAE bus interface 604 then relays the response from inter-CAE bus controller 200 to control logic 600 in the form of status signal 616.

If status signals 614 and 616 indicate that the destination devices are available to receive data, control logic 600 then issues certain control signals to drive data to the appropriate destination devices. For instance, control logic 600 may assert register enable signal 626 to drive data temporarily stored in register 610 to neighboring CAEs. Alternatively, control logic 600 may assert multiplexer control signal 628 to instruct multiplexer 602 to pass through certain information to sequencer 400 and/or CAE memory 402. Certain data are placed in FIFO 606 and FIFO 608 before they are driven to their final destinations. These FIFOs are provided to smooth out any peak congestion conditions that data router 406 may experience. After data router 406 places data in FIFOs 606 and 608, control logic 600 then asserts status signals 630 to indicate that data router 406 is available to receive new data.

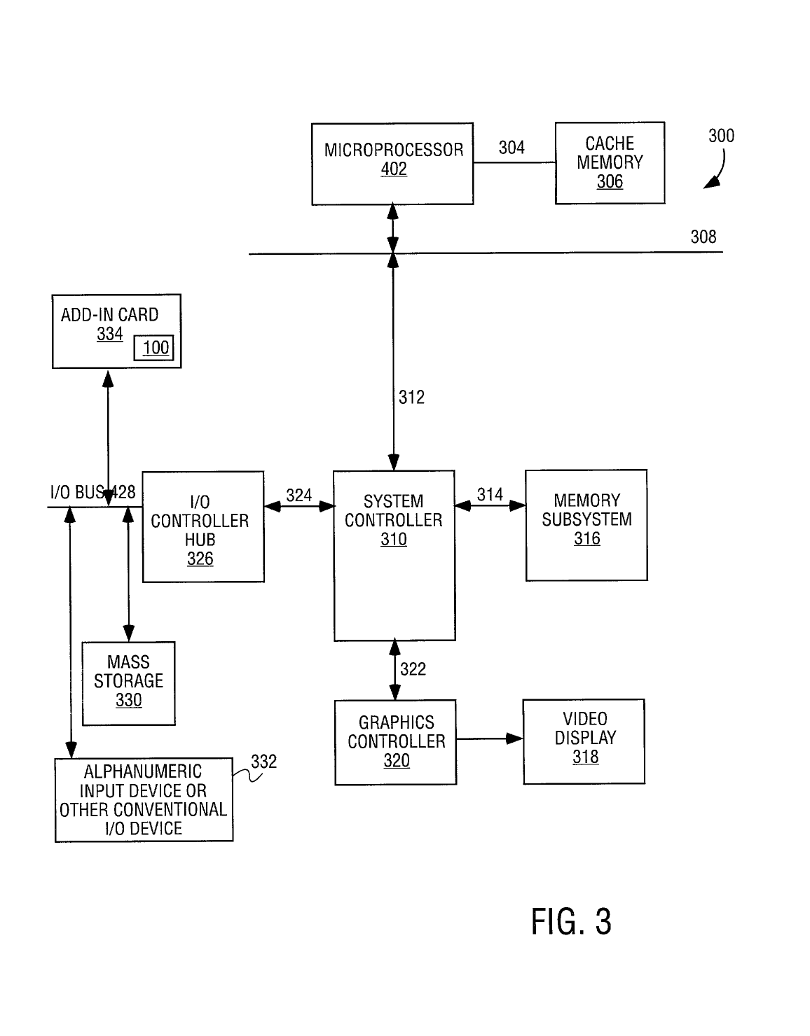

FIG. 3 illustrates a block diagram of general-purpose computer system 300 that includes one embodiment of re-targetable communication system 100. Specifically, re-targetable communication system 100 resides on add-on card 334, which couples to I/O bus 328. Together with add-on card 334, re-targetable communication system 100 handles multiple types of communication data for computer system 300. Some examples of the communication data are, but not limited to, data that conform to standards for digital subscriber lines, cable modems, integrated services digital network, T-1 lines, wireless communications, modems, etc.

The general-purpose computer system architecture comprises microprocessor 302 and cache memory 306 coupled to each other through processor bus 304. Sample computer system 300 also includes high performance system bus 308 and standard I/O bus 328. Coupled to high performance system bus 308 are microprocessor 302 and system controller 310. Additionally, system controller 310 is coupled to memory subsystem 316 through channel 314, is coupled to I/O controller hub 326 through link 324 and is coupled to graphics controller 320 through interface 322. Coupled to graphics controller 320 is video display 318. Aside from the mentioned add-on card 334, coupled to standard I/O bus 328 are I/O controller hub 326, mass storage 330 and alphanumeric input device or other conventional input device 332.

These elements perform their conventional functions well known in the art. Moreover, it should have been apparent to one ordinarily skilled in the art that computer system 300 could be designed with multiple microprocessors 302 and may have more components than that which is shown. It should also have been apparent to one with ordinary skill in the art to implement re-targetable communication system 100 in other systems than computer system 300 without exceeding the scope of the present invention.

Thus, a re-targetable communication system has been described. Although the present has been described particularly with reference to the figures and to specific examples, it will be apparent to one of the ordinary skill in the art that the present invention may appear in any of a number of other communication system architectures. It is contemplated that many changes and modifications may be made by one of ordinary skill in the art without departing from the spirit and scope of the present invention.

### Appendix A

William E. Alford, Reg. No. 37,764; Farzad E. Amini, Reg. No. 42,261; William Thomas Babbitt, Reg. No. 39,591; Carol F. Barry, Reg. No. 41,600; Jordan Michael Becker, Reg. No. 39,602; Lisa N. Benado, Reg. No. 39,995; Bradley J. Bereznak, Reg. No. 33,474; Michael A. Bernadicou, Reg. No. 35,934; Roger W. Blakely, Jr., Reg. No. 25,831; R. Alan Burnett, Reg. No. 46,149; Gregory D. Caldwell, Reg. No. 39,926; Andrew C. Chen, Reg. No. 43,544; Thomas M. Coester, Reg. No. 39,637; Donna Jo Coningsby, Reg. No. 41,684; Florin Corie, Reg. No. 46,244; Dennis M. deGuzman, Reg. No. 41,702; Stephen M. De Klerk, Reg. No. 46,503; Michael Anthony DeSanctis, Reg. No. 39,957; Daniel M. De Vos, Reg. No. 37,813; Sanjeet Dutta, Reg. No. 46,145; Matthew C. Fagan, Reg. No. 37,542; Tarek N. Fahmi, Reg. No. 41,402; George Fountain, Reg. No. 37,374; James Y. Go, Reg. No. 40,621; James A. Henry, Reg. No. 41,064; Libby N. Ho, Reg. No. 46,774; Willmore F. Holbrow III, Reg. No. 41,845; Sheryl Sue Holloway, Reg. No. 37,850; George W Hoover II, Reg. No. 32,992; Eric S. Hyman, Reg. No. 30,139; William W. Kidd, Reg. No. 31,772; Sang Hui Kim, Reg. No. 40,450; Walter T. Kim, Reg. No. 42,731; Eric T. King, Reg. No. 44,188; George Brian Leavell, Reg. No. 45,436; Kurt P. Leyendecker, Reg. No. 42,799; Gordon R. Lindeen III, Reg. No. 33,192; Jan Carol Liffle, Reg. No. 41,181; Robert G. Litts, Reg. No. 46,876; Joseph Lutz, Reg. No. 43,765; Michael J. Mallie, Reg. No. 36,591; Andre L. Marais, under 37 C.F.R. § 10.9(b); Paul A. Mendonsa, Reg. No. 42,879; Clive D. Menezes, Reg. No. 45,493; Chun M. Ng, Reg. No. 36,878; Thien T. Nguyen, Reg. No. 43,835; Thinh V. Nguyen, Reg. No. 42,034; Dennis A. Nicholls, Reg. No. 42,036; Robert B. O'Rourke, Reg. No. 46,972; Daniel E. Ovanezian, Reg. No. 41,236; Kenneth B. Paley, Reg. No. 38,989; Gregg A. Peacock, Reg. No. 45,001; Marina Portnova, Reg. No. 45,750; William F. Ryann, Reg. 44,313; James H. Salter, Reg. No. 35,668; William W. Schaal, Reg. No. 39,018; James C. Scheller, Reg. No. 31,195; Jeffrey Sam Smith, Reg. No. 39,377; Maria McCormack Sobrino, Reg. No. 31,639; Stanley W. Sokoloff, Reg. No. 25,128; Judith A. Szepesi, Reg. No. 39,393; Vincent P. Tassinari, Reg. No. 42,179; Edwin H. Taylor, Reg. No. 25,129; John F. Travis, Reg. No. 43,203; Joseph A. Twarowski, Reg. No. 42,191; Tom Van Zandt, Reg. No. 43,219; Lester J. Vincent, Reg. No. 31,460; Glenn E. Von Tersch, Reg. No. 41,364; John Patrick Ward, Reg. No. 40,216; Mark L. Watson, Reg. No. 46,322; Thomas C. Webster, Reg. No. 46,154; and Norman Zafman, Reg. No. 26,250; my patent attorneys, and Firasat Ali, Reg. No. 45,715; Justin M. Dillon, Reg. No. 42,486; Thomas S. Ferrill, Reg. No. 42,532; and Raul Martinez, Reg. No. 46,904, my patent agents, of BLAKELY, SOKOLOFF, TAYLOR & ZAFMAN LLP, with offices located at 12400 Wilshire Boulevard, 7th Floor, Los Angeles, Calif. 90025, telephone (310) 207-3800, and Alan K. Aldous, Reg. No. 31,905; Edward R. Brake, Reg. No. 37,784; Ben Burge, Reg. No. 42,372; Jeffrey S. Draeger, Reg. No. 41,000; Cynthia Thomas Faatz, Reg No. 39,973; John N. Greaves, Reg. No. 40,362; Seth Z. Kalson, Reg. No. 40,670; David J. Kaplan, Reg. No. 41,105; Peter Lam, Reg. No. 44,855; Charles A. Mirho, Reg. No. 41,199; Leo V. Novakoski, Reg. No. 37,198; Thomas C. Reynolds, Reg. No. 32,488; Kenneth M. Seddon, Reg. No. 43,105; Mark Seeley, Reg. No. 32,299; Steven P. Skabrat, Reg. No. 36,279; Howard A. Skaist, Reg. No. 36,008; Gene I. Su, Reg. No. 45,140; Calvin E. Wells, Reg. No. P43,256, Raymond J. Werner, Reg. No. 34,752; Robert G. Winkle, Reg. No. 37,474; Steven D. Yates, Reg. No. 42,242; and Charles K. Young, Reg. No. 39,435; my patent attorneys, of INTEL CORPORATION; and James R. Thein, Reg. No. 31,710, my patent attorney with full power of substitution and revocation, to prosecute this application and to transact all business in the Patent and Trademark Office connected herewith.

### Appendix B

### Title 37, Code of Federal Regulations, Section 1.56 Duty to Disclose Information Material to Patentability

(a) A patent by its very nature is affected with a public interest. The public interest is best served, and the most effective patent examination occurs when, at the time an application is being examined, the Office is aware of and evaluates the teachings of all information material to patentability. Each individual associated with the filing and prosecution of a patent application has a duty of candor and good faith in dealing with the Office, which includes a duty to disclose to the Office all information known to that individual to be material to patentability as defined in this section. The duty to disclosure information exists with respect to each pending claim until the claim is cancelled or withdrawn from consideration, or the application becomes abandoned. Information material to the patentability of a claim that is cancelled or withdrawn from consideration need not be submitted if the information is not material to the patentability of any claim remaining under consideration in the application. There is no duty to submit information which is not material to the patentability of any existing claim. The duty to disclosure all information known to be material to patentability is deemed to be satisfied if all information known to be material to patentability of any claim issued in a patent was cited by the Office or submitted to the Office in the manner prescribed by §§1.97(b)-(d) and 1.98. However, no patent will be granted on an application in connection with which fraud on the Office was practiced or attempted or the duty of disclosure was violated through bad faith or intentional misconduct. The Office encourages applicants to carefully examine:

(1) Prior art cited in search reports of a foreign patent office in a counterpart application, and

(2) The closest information over which individuals associated with the filing or prosecution of a patent application believe any pending claim patentably defines, to make sure that any material information contained therein is disclosed to the Office.

(b) Under this section, information is material to patentability when it is not cumulative to information already of record or being made or record in the application, and

(1) It establishes, by itself or in combination with other information, a prima facie case of unpatentability of a claim; or

(2) It refutes, or is inconsistent with, a position the applicant takes in:

(i) Opposing an argument of unpatentability relied on by the Office, or

(ii) Asserting an argument of patentability.

A prima facie case of unpatentability is established when the information compels a conclusion that a claim is unpatentable under the preponderance of evidence, burden-of-proof standard, giving each term in the claim its broadest reasonable construction consistent with the specification, and before any consideration is given to evidence which may be submitted in an attempt to establish a contrary conclusion of patentability.

(c) Individuals associated with the filing or prosecution of a patent application within the meaning of this section are:

(1) Each inventor named in the application;

(2) Each attorney or agent who prepares or prosecutes the application; and

(3) Every other person who is substantively involved in the preparation or prosecution of the application and who is associated with the inventor, with the assignee or with anyone to whom there is an obligation to assign the application.

(d) Individuals other than the attorney, agent or inventor may comply with this section by disclosing information to the attorney, agent, or inventor.

What is claimed is:

1. A re-targetable communication processor, comprising:
a. a connectivity unit;
b. a digital signal processing core coupled to the connectivity unit;
c. a plurality of scaleable functional units, coupled to the connectivity unit, to execute mathematically intensive operations, further including:
a local memory;
a plurality of removable complex arithmetic elements (hereinafter CAE) coupled to one another, to the local memory and to an inter-CAE bus; and
a bus controller coupled to the inter-CAE bus and the connectivity unit.

2. The re-targetable communication processor according to claim 1, the CAE further comprising:
a. a CAE memory to store data for the mathematically intensive operations;
b. a sequencer, coupled to an arithmetic unit, a data router and the CAE memory, to generate addresses and control information;
c. the arithmetic unit, coupled to the CAE memory and the data router, optimized to execute operations in accordance with the control information; and
d. the data router to route data to the sequencer and the CAE memory and to facilitate communications among the CAEs in the scaleable functional unit.

3. The re-targetable communication processor according to claim 2, the CAE memory further comprising:
two banks of separately addressable data memories.

4. The re-targetable communication processor according to claim 3, the arithmetic unit further comprising:
a. a register file to accept data from the data memories; and
b. a plurality of multiplier-accumulator engines, coupled to one another, to the register file and to the data memories, to operate on the mathematically intensive operations.

5. The re-targetable communication processor according to claim 4, the multiplier-accumulator engine further comprising:
a. a pre-adder to generate a first sum by adding data from the register file and the data memory;
b. a multiplier to generate a multiplier output by multiplying data from the data memories or the first sum;
c. an accumulator to generate a second sum by adding the multiplier output or data from the data memories; and
d. a data packing block to configure the second sum into a pre-defined format.

6. The re-targetable communication processor according to claim 5, the multiplier further including a programmable shifter.

7. The re-targetable communication processor according to claim 1, the CAEs are coupled to one another via an east port, a west port and the inter-CAE port.

8. The re-targetable communication processor according to claim 1, further including a micro-controller core coupled to the connectivity unit.

9. The re-targetable communication processor according to claim 2, wherein a first delay introduced by the sequencer matches a second delay introduced by the arithmetic unit.

10. A scaleable functional unit in a re-targetable communication processor, comprising:
a. a local memory;
b. a plurality of removable complex arithmetic elements (hereinafter CAE) coupled to one another, to the local memory and to an inter-CAE bus; and
c. a bus controller coupled to the inter-CAE bus and the connectivity unit.

11. The scaleable functional unit according to claim 10, the CAE further comprising:
a. a CAE memory to store data for the mathematically intensive operations;
b. a sequencer, coupled to an arithmetic unit, a data router and the CAE memory, to generate addresses and control information;
c. the arithmetic unit, coupled to the CAE memory and the data router, optimized to execute operations in accordance with the control information; and
d. the data router to route data to the sequencer and the CAE memory and to facilitate communications among the CAEs in the scaleable functional unit.

12. The scaleable functional unit according to claim 11, the CAE memory further comprising:
two banks of separately addressable data memories.

13. The scaleable functional unit according to claim 12, the arithmetic unit further comprising:
a. a register file to accept data from the data memories; and
b. a plurality of multiplier-accumulator engines, coupled to one another, to the register file and to the data memories, to operate on the mathematically intensive operations.

14. The scaleable functional unit according to claim 13, the multiplier-accumulator engine further comprising:
a. a pre-adder to generate a first sum by adding data from the register file and the data memory;
b. a multiplier to generate a multiplier output by multiplying data from the data memories or the first sum;
c. an accumulator to generate a second sum by adding the multiplier output or data from the data memories; and
d. a data packing block to configure the second sum into a pre-defined format.

15. The scaleable functional unit according to claim 14, the multiplier further including a programmable shifter.

16. The scaleable functional unit according to claim 10, the CAEs are coupled to one another via an east port, a west port and the inter-CAE port.

17. The scaleable functional unit according to claim 11, wherein a first delay introduced by the sequencer matches a second delay introduced by the arithmetic unit.

18. A computer system, comprising:
a microprocessor coupled to a system bus;
a system controller coupled to the system bus; and
an input/output controller hub, coupled to the system controller and coupled to an input/output bus;
an add-in card, coupled to the input/output bus, further including:
a re-targetable communication system, comprising:
a. a connectivity unit;
b. a digital signal processing core coupled to the connectivity unit;
c. a plurality of scaleable functional units, coupled to the connectivity unit, to execute mathematically intensive operations, further including:
i. a local memory;
ii. a plurality of removable complex arithmetic elements (hereinafter CAE) coupled to one another, to the local memory and to an inter-CAE bus; and
iii. a bus controller coupled to the inter-CAE bus and the connectivity unit.

19. The computer system according to claim 18, the CAE further comprising:
a. a CAE memory to store data for the mathematically intensive operations;
b. a sequencer, coupled to an arithmetic unit, a data router and the CAE memory, to generate addresses and control information;
c. the arithmetic unit, coupled to the CAE memory and the data router, optimized to execute operations in accordance to the control information; and
d. the data router to route data to the sequencer and the CAE memory and to facilitate communications among the CAEs in the scaleable functional unit.

20. The computer system according to claim 19, the CAE memory further comprising:
two banks of separately addressable data memories.

21. The computer system according to claim 20, the arithmetic unit further comprising:
a. a register file to accept data from the data memories; and
b. a plurality of multiplier-accumulator engines, coupled to one another, to the register file and to the data memories, to operate on the mathematically intensive operations.

22. The computer system according to claim 21, the multiplier-accumulator engine further comprising:
a. a pre-adder to generate a first sum by adding data from the register file and the data memory;
b. a multiplier to generate a multiplier output by multiplying data from the data memories or the first sum;
c. an accumulator to generate a second sum by adding the multiplier output and data from the data memories; and
d. a data packing block to configure the second sum into a pre-defined format.

23. The computer system according to claim 22, the multiplier further including a programmable shifter.

24. The computer system according to claim 18, the CAEs are coupled to one another via an east port, a west port and the inter-CAE port.

25. The computer system according to claim 18, wherein the re-targetable communication system further including a micro-controller core that is coupled to the connectivity unit.

26. The computer system according to claim 19, wherein a first delay introduced by the sequencer matches a second delay introduced by the arithmetic unit.
